(19) United States
(12) Patent Application Publication
(10) Pub. No.: US 2007/0107166 A1
(43) Pub. Date: May 17, 2007

(54) Radially slotted ring having an elastically variable diameter, especially a retaining ring

(75) Inventors: August Kästner, Welzheim (DE); Hermann Weller, Alfdorf (DE)

Correspondence Address: WILLIAM COLLARD;COLLARD & ROE, P.C., 1077 NORTHERN BOULEVARD, ROSLYN, NY, 11576, US

(73) Assignee: CHRISTIAN BAUER GMBH + CO.KG, Welzheim (DE)

(21) Appl. No.: 10/576,996

(22) PCT Filed: Sep. 13, 2005
(86) PCT No.: PCT/DE05/01598

§ 371 Date: Apr. 25, 2006

(30) Foreign Application Priority Data
Oct. 26, 2004 (DE) 10 2004 052 105.0

(51) Int. Cl. F16L 33/00

(52) U.S. Cl. 24/16 R

(57) ABSTRACT

The invention relates to a radially slotted ring having an elastically variable diameter, in particular a retaining ring, is to be transportable as a bulk material without complications and it should be suitable for final grinding to an axial thickness dimension with a high manufacturing precision. This ring (1) comprises a radial slot (2) that is filled at least partially with a filler material (3) which is easily removed prior to use of this ring (1) for its proper function, the filler material serving as a shipping and/or machining aid. The filler material (3) consists in particular of the material of the ring and is already manufactured in the primary shaping of the ring (1) together with this ring so that it can be separated easily from the ring.

The invention relates to a radially slotted ring, in particular a retaining ring, having an elastically variable diameter. This includes in particular axially securable spring rings, which are frequently also referred to in practice as Seeger circlip rings according to the original manufacturer.

With such retaining rings, the slot width usually exceeds the axial thickness of the ring. This makes it possible for the rings to become interlinked through their slots in the manner of chain links. This property is a disadvantage in particular when such retaining rings or any other such rings are shipped loosely in bulk. This results from the fact that rings interlinked in the manner of chain links have always had to be separated by hand in a tedious operation. This in turn means that retaining rings shipped as bulk goods cannot usually be picked up out of the bulk goods and installed using automatic tools. Instead, they must always be removed manually from the bulk goods to permit isolation of rings that are joined together in the manner of chain links.

For certain applications in which the retaining rings must have an axial thickness with a very small tolerance, in which case such a tolerance may be in the range of only a few micrometers, the retaining rings obtained by primary shaping must be ground on their flanks. Such grinding is usually performed by mounting a retaining ring in a form-fitting manner in the opening of a conveyor belt, which has a smaller thickness at its outside diameter in comparison with the thickness of the retaining ring and by moving it between two grinding disks to produce the final axial dimensions of the retaining ring. Due to the radial slot in the retaining ring, vibrations are induced during the grinding operation. These vibrations cause an axial displacement of the retaining ring during the grinding operation, so that the completely ground and polished retaining ring may have unacceptable thickness tolerances.

This invention relates primarily to the problem of reliably avoiding entanglement of individual rings in the manner of chain links, especially in bulk transport of such rings. In addition, generic rings which must be ground to an extremely precise axial machining dimension after the original shaping should be easy to manufacture with absolute precision.

This complex of problems can be solved primarily by designing a generic ring according to the characterizing feature of patent claim 1.

Advantageous and expedient embodiments are the object of the subordinate claims.

The invention is based on the general idea of eliminating the causative factor for entanglement of the generic rings like chain links in transport of these rings, because said causative factor results in lack of precision in manufacturing in finished grinding of rings after primary shaping in the same way and exists in the radial slot of the ring as such for the duration of time during which the rings are being transported and processed to their final form. The elimination of this problem consists of at least partially filling the slot width in such a way that entanglement of the rings with one another in the manner of chain links is therefore no longer possible due to the fact that a ring can no longer simply slip through the slot in the other ring. To fulfill this purpose, partial filling of the slot is sufficient to eliminate the main problem which is to be solved by the present invention, namely the elimination of a mutual entanglement of the rings.

Furthermore, if an additional goal of the invention is to be achieved, namely increasing the manufacturing precision in grinding an originally shaped ring, then the radial slot in the circumferential direction should be filled as completely as possible to thereby completely prevent any slot-induced vibrations in the ring in the grinding process.

Essentially the filling material for at least partial filling of the radial ring slot may be of any desired type if it is easily introduced into the ring on the one hand and in particular is easily separated, especially before use of the ring for its proper function in which the slot must be open. After such separation, preferably there should not be any need for post-processing. Any desired filler piece inserted after the original shaping of a ring should meet these requirements. For rings that are to be reground axially, the filler material should not protrude out of the slot at least in the axial direction of the radial slot of the retaining ring.

It is especially advantageous to provide the filler material already at the time of original shaping of a ring. Generic rings and in particular retaining rings are usually shaped primarily by stamping them out of a flat sheet of material. In such a manufacturing method, a continuous bridge may be created in the slot with intended breaking points at the edges of the slot. The intended breaking points can be implemented here as notches. Such molded bridges may be extremely narrow webs. The size may be selected to be so small that there is sufficient strength to prevent unintentional separation of these webs. Essentially it is sufficient for such a bridge web to be joined securely to only one of the two opposing slot flanks, i.e., extending from this flank outward into the slot, because during transport as a bulk material this reliably prevents mutual entanglement of slotted rings in the ready-to-use state. If the slot is almost completely filled up in the circumferential direction, such an embodiment may also be sufficient for a precision regrinding of rings.

Filling material provided according to this invention for shipping and machining purposes can be removed easily before use of such a ring for the proper function, i.e., before installation of such rings. This is true in particular when using automatic assembly machines in which a separation mechanism for the filling material in the slots of the rings can be installed easily.

An advantageous exemplary embodiment of the present invention is illustrated in the drawing with respect to a retaining ring.

The drawings show:

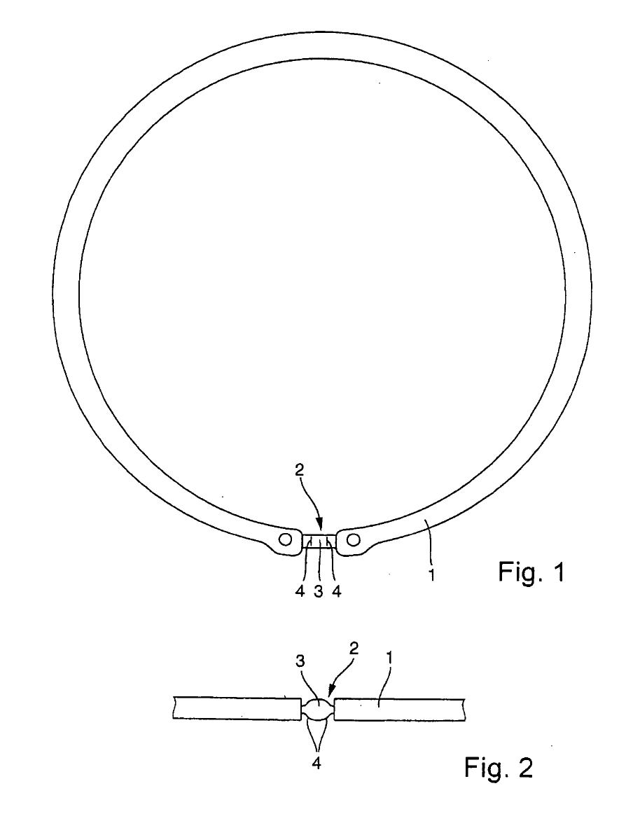

FIG. 1 a top view of a retaining ring in the form of a Seeger circlip ring,

FIG. 2 a side view of the slot area of the retaining ring.

A conventional retaining ring 1 originally shaped by stamping out of flat strip material has a radial slot 2 as is necessarily required for its function as an internally or externally clamping spring ring.

This radial slot 2 is filled according to this invention with a connecting web 3 in the form of a bridge which is integrally molded in stamping. Notches in the form of intended breaking points 4 are formed in the respective transitional areas to the flanks of the radial slot 2 in the properly installed state of the retaining ring 1.

All the features characterized in the description and in the following claims may be essential to this invention either individually or combined in any form.

1-6. (canceled)

7. A radially slotted ring having an elastically variable diameter, in particular a locking ring, wherein its radial slot (2) filled with an easily removable filer material (3) while the ring (1) is still in an unstressed manufacturing state, said filler material serving as an aid in shipping and/or processing.

8. The ring according to claim 7, wherein the radial slot (2) is filled completely with filler material (3).

9. The ring according to claim 8, wherein the filler material (3) consists of the same material as the ring (1) and easy separability is provided by at least one intended breaking point (4).

10. The ring according to claim 9, wherein the at least one intended breaking point (4) is created already at the time of original shaping of the ring (1).

11. The ring according to claim 9, wherein the at least one intended breaking point (4) is designed as a notch.

12. The ring according to claim 7, wherein the ring (1) is a spring which is radially inwardly clamping or radially outwardly clamping.
